(19) United States
(12) Patent Application Publication
(10) Pub. No.: US 2002/0188649 A1
(43) Pub. Date: Dec. 12, 2002

(54) Mechanism for safely executing an untrusted program

(76) Inventor: Ron Karim, San Jose, CA (US)

Correspondence Address: HICKMAN PALERMO TRUONG & BECKER, LLP, 1600 WILLOW STREET, SAN JOSE, CA, 95125, US

(21) Appl. No.: 09/880,231

(22) Filed: Jun. 12, 2001

(51) Int. Cl. G06F 9/00

(52) U.S. Cl. 709/104

(57) ABSTRACT

An untrusted program is initially executed in a limited environment comprising mock resources. After execution, a diagnostic is run on the limited environment to determine whether the untrusted program exhibited any undesirable behavior (e.g. whether the untrusted program deleted, modified, renamed, etc. the mock resources). If undesirable behavior is detected, corrective action may be taken. Corrective action may include providing a warning to a user not to run the untrusted program in an unrestricted environment, and deleting the untrusted program. By prescreening an untrusted program in a limited and safe environment in this manner, it is possible to detect malignant programs and to prevent them from doing any real damage to a system.

### FIELD OF THE INVENTION

This invention relates generally to computer systems, and more particularly to a mechanism for safely executing an untrusted program.

### BACKGROUND

Over the years, computer viruses have wreaked havoc on large-scale and small-scale computer systems alike. Ranging from merely annoying to highly destructive, computer viruses have caused tremendous amounts of resources to be wasted. For example, great amounts of resources have been devoted to removing viruses from computer systems (which may involve inspecting and cleansing each individual computer) and to repairing the damage caused by viruses (which may involve recovering damaged files from backed up copies and even recreating some or all of the contents of damaged files). Overall, computer viruses have been a bane to countless computer users, and with the number and sophistication of hackers and virus developers ever increasing, the computer virus problem is projected to only get worse. Viruses have become such a serious problem, in fact, that they have spawned their own industry: the anti-virus industry, the sole purpose of which is to counter viruses. Despite the presence of this industry, though, the computer virus problem has still not been eradicated.

Currently, the approach taken by the anti-virus industry is a reactive one. That is, the industry waits until a new virus is encountered, and then reacts to the virus by creating a remedy (i.e. an anti-virus program). The problem with this approach is that it gives every new virus at least “one free bite”. That is, until some unfortunate user encounters and feels the effects of a new virus, the anti-virus industry does not have any knowledge of the virus, and until the industry knows of the virus, the industry cannot study it and hence cannot create a remedy for it. This means that by the time a remedy is created, it is already too late for those unfortunate users who have already encountered the virus.

To make this problem worse, computer viruses are usually spread in a very short period of time to a large number of users. As a result, by the time the anti-virus industry even learns about a virus, the virus has already affected a large number of users. Add to this the fact that it requires a significant amount of time to develop a remedy for a virus, and it becomes clear that by the time a remedy is provided, a vast amount of damage will have already been done. The anti-virus industry is currently unable to prevent this initial damage from occurring. Because of its inability to prevent damage, the current reactive approach to computer viruses leaves much to be desired.

### SUMMARY OF THE INVENTION

In view of the shortcomings of the prior art, the present invention provides an improved methodology for addressing computer viruses specifically, and untrusted programs in general. The present invention is based, at least partially, upon the observation that an untrusted computer program (e.g. a virus) can cause damage only if it is allowed to execute in an environment in which it can access actual important resources. If, instead of executing the program in such an environment, the program is run in a limited mock environment, then the program cannot do any real harm. Even if the program is a destructive virus, if it can access only mock or dummy resources in a limited environment, it cannot damage any of the important resources of the system. As a result, the program may be allowed to run freely in the mock environment without any fear of real damage.

After the program is executed in the mock environment, a diagnostic may be run to check the environment for signs of undesirable behavior. For example, the diagnostic may check for deleted files, modified files, renamed files, etc. If the diagnostic reveals any undesirable behavior on the part of the program, then corrective action may be taken. For example, a user may be warned that the program is potentially a virus and hence should not be run, or the program may be deleted. If the program does not exhibit any undesirable behavior, then it may be run in the actual system environment. By running an untrusted program in a mock environment first, the behavior of the program may be determined in an environment in which it is safe to do so. Only if the program does not exhibit any undesirable behavior will it be allowed to execute in a real environment. By prescreening a program in this manner, the present invention is able to prevent an untrusted program from doing any actual damage to a system. Because it is able to prevent damage rather than just react to damage that has already been done, the present invention provides a significant improvement over the prior art.

### BRIEF DESCRIPTION OF THE DRAWINGS

FIG. 1 is functional block diagram of a system in which one embodiment of the present invention may be implemented.

FIG. 2 is a flow diagram illustrating the operational flow of one embodiment of the present invention.

FIG. 3 is a hardware block diagram of a computer system in which one embodiment of the present invention may be implemented.

### DETAILED DESCRIPTION OF EMBODIMENT(S)

### Functional Overview

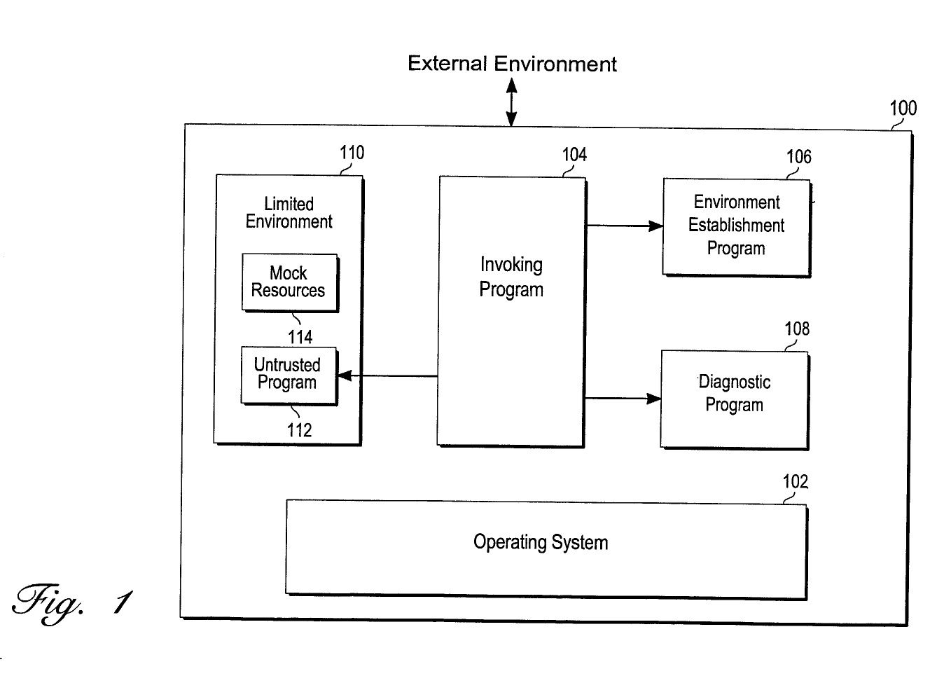

With reference to FIG. 1, there is shown a functional block diagram of a computer system 100 in which one embodiment of the present invention may be implemented. As shown, system 100 comprises an operating system 102, an invoking program 104, an environment establishment program 106, and a diagnostic program 108.

In system 100, the operating system 102 provides the low level functionality relied upon by the other programs. For example, the operating system 102 provides functions for reading data from and writing data to a mass storage (not shown), allocating and deallocating memory, providing I/O, implementing a user interface, as well as other functions. These functions are invoked by the other programs during execution. Overall, the operating system 102 provides all of the basic, low level utilities that the other programs need to operate. For purposes of the present invention, the operating system 102 may be any operating system, including but not limited to a UNIX-based operating system, DOS, and Windows.

One of the capabilities of the operating system 102 is the ability to establish a limited environment in which a program may be executed. This limited environment may limit, for example, the type of resources that a program can call upon, the amount of memory that the program can use, and the areas of a mass storage (e.g. a hard drive) that the program can access. The manner in which this limited environment is established differs from operating system to operating system.

In a UNIX-based operating system, for example, a limited environment may be established by creating a UNIX shell. More specifically, for a particular shell, the operating system 102 can set the root directory for that shell. With the root directory thus set, any program executing within the shell will be able to access only the resources in the root directory and any sub directories of the root directory. The program will not be able to access or even detect the existence of any other directory. As far as the program is concerned, it is as if the root directory and its sub directories were the only directories in the file system. By setting up a shell in this manner, the operating system 102 can effectively limit the resources that a program can access. For example, if the root directory for a shell is set, not to the actual root directory of the system but rather to some sub directory, then any program executing in that shell will not be able to access all of the resources in the system, but rather can access only the resources reachable from the sub directory. Because the program cannot access any of the other directories, those directories are protected from the program. The significance of running a program in a limited environment will be elaborated upon in a later section.

A sample limited environment is shown in FIG. 1 as block 110. As shown, the limited environment 110 comprises one or more mock resources 114. As noted above, a limited environment 110 may have a root directory associated therewith. In such a case, the mock resources 114 may reside within that root directory, or a sub directory thereof. The mock resources 114 may be any type of resource. For example, they may comprise mock files that contain mock or dummy data. In addition, they may comprise mock devices, such as fake ports and fake I/O devices, as well as any other type of mock resource. As the name implies, the mock resources 114, in one embodiment, are not actual resources. That is, the mock devices are not real devices, and the mock or dummy files do not contain actual data, although they do contain mock/dummy data. As used herein, the term mock/dummy data refers to data that is not relied upon by any program for proper operation, and that does not represent any “real” data. In a sense, mock/dummy data is “pretend” data. Because the mock resources 114 are not real resources, even if they are altered, deleted, etc., no real harm is done.

While in actuality the mock resources 114 do not represent any real data or real devices, they are quite real to any program running within the limited environment 110. The program can manipulate the mock resources 114 in the same way that it would manipulate any real resource. For example, the program can access, read, modify, move, and delete a mock file. Likewise, the program can invoke a mock device just as it can a real device. Overall, the program cannot distinguish the mock resources 114 from any other resource. Hence, while it runs in the limited environment 110, the program behaves just as it would in an actual unlimited environment. This is advantageous because it allows the true behavior of the program to be exhibited.

One of the possible uses of the limited environment 110 and the mock resources 114 is to test an untrusted program 112 (a program that is not known to be benign). More specifically, an untrusted program 112 may be executed in the limited environment 110 and allowed to manipulate the mock resources 114 freely. After the untrusted program 112 is run, the limited environment 110 and the mock resources 114 may be checked to determine whether the untrusted program 112 exhibited any undesirable behavior. For example, the environment 110 may be checked to see if any mock files were deleted, modified, or accessed. If any undesirable behavior is detected, then the untrusted program 112 may be determined to be a high risk program (e.g. a virus), and corrective action may be taken. Because the mock resources 114 may be used to test untrusted programs 112, they may be configured to be especially attractive to virus programs. For example, the names of the mock files 114 may be chosen such that they coincide with important system files (e.g. config.sys or autoexec.bat). The file names may also coincide with files that are frequently accessed by viruses (e.g. an address list). By making the mock resources 114 attractive targets, the chances of detecting undesirable behavior in a malignant program are improved.

In system 100, the program that sets up the limited environment is the environment establishment program 106. This program 106 may take many different forms, and the form that it takes depends upon the particular operating system 102. For a UNIX-based operating system, for example, the program 106 may take the form of a script file. This script file may comprise invocation(s) of the shell creation capability of the operating system 102 to give rise to a shell. The program 106 may specify to the operating system 102 the directory that should be the root directory for that shell. In addition, the program 106 may specify other limitations for the shell (e.g. a limit on how much memory may be used by the programs executing in that shell). Overall, the environment establishment program 106 invokes all of the necessary operating system functions, and performs all of the necessary operations to set up the limited environment 110. Once the limited environment is established, an untrusted program 112 may be executed within it.

In system 100, the program that is responsible for running an untrusted program within the limited environment 110 is the invoking program 104. In one embodiment, the invoking program 104 is the program through which an untrusted program enters the system 100. For example, program 104 may be an electronic mail (email) program that downloads emails from a mail server (not shown) from the external environment. Since these emails may have untrusted programs attached to them, the untrusted programs enter the system 100 via the email program. For the sake of illustration, it will be assumed in the following discussion that program 104 is an email program since email is currently the mechanism through which viruses are most prevalently propagated. It should be noted, though, that program 104 is not so limited. Rather, program 104 may be any type of program. So long as a program is able to invoke an untrusted program, it can serve as the invoking program 104.

In one embodiment, in invoking an untrusted program, the invoking program 104 does not initially run the untrusted program in an unlimited environment. Instead, program 104 first invokes the environment establishment program 106 to set up a limited environment 110. After the limited environment 110 is established, the invoking program 104 executes the untrusted program 112 within the limited environment 110. By doing so, the invoking program 104 prevents the untrusted program 112, should it turn out to be a malignant program, from damaging actual system resources. In executing the untrusted program 112, the invoking program 104 may allow the untrusted program 112 to run to completion, or it may halt the untrusted program 112 after partial execution. In either case, after the untrusted program 112 has executed, the invoking program 104 invokes the diagnostic program 108.

In one embodiment, it is the responsibility of the diagnostic program 108 to inspect the limited environment 110 after execution of the untrusted program 112 to check for indications of undesirable behavior on the part of the untrusted program 112. In carrying out its responsibility, the diagnostic program 108 may perform a number of different checks. For example, the diagnostic program 108 may determine: (1) whether any of the mock files 114 were deleted; (2) whether any of the mock files 114 were modified (this may be done, for example, by determining whether the “last modified time” parameters associated with the files have changed); and (3) whether any of the mock files 114 were renamed or moved. In addition, the diagnostic program 108 may determine whether any of the mock files 114 were read by the untrusted program 112. This may be done, for example, by scanning the memory for certain contents of the files. For instance, if the files contain a particular email address, then the memory may be scanned for that particular email address. If the email address is found, then it means, most likely, that at least one of the mock files 114 was accessed. These and other checks may be performed by the diagnostic program 108. For purposes of the present invention, the diagnostic program 108 may be as sophisticated as desired, and may check for any type of undesirable behavior on the part of the untrusted program 112.

After the diagnostic is performed, the diagnostic program 108 may perform one or more tasks. For example, it may provide a report of the behavior exhibited by the untrusted program 112 (e.g. which files were deleted, modified, accessed, etc.). In addition, the diagnostic program 108 may, based upon the behavior of the untrusted program 112, make a determination as to whether the untrusted program 112 exhibited any undesirable behavior. If so, the diagnostic program 108 may take corrective action. For example, it may send a warning message to a user indicating that the untrusted program may be a malignant program, or it may delete the untrusted program 112 from the system, or it may take any other corrective action. On the other hand, if no undesirable behavior is detected, then the diagnostic program 108 may inform the invoking program 104 that the untrusted program 112 is probably a benign program. In such a case, the invoking program 104 may allow the untrusted program 104 to be run in an unrestricted environment. In the manner described above, the system 100 prescreens an untrusted program 112. Only if the untrusted program 112 is determined to be benign will it be allowed to run in an unrestricted environment. By doing so, system 100 prevents a malignant program from doing any actual damage.

### SYSTEM OPERATION

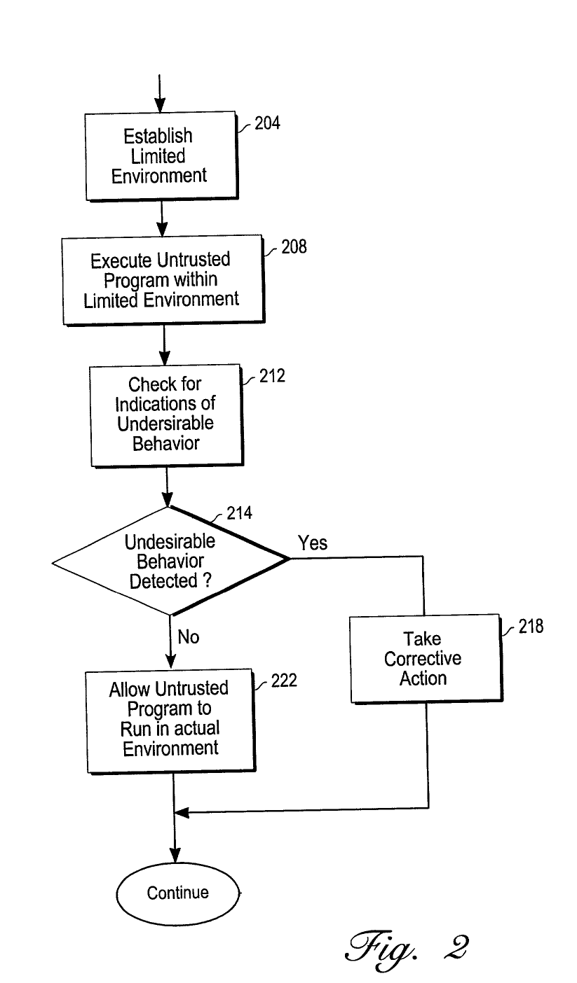

An overview of the system 100 has been disclosed. With reference to the flow diagram of FIG. 2, the operation of the system 100 will now be described. As mentioned previously, in one embodiment, an untrusted program 112 enters the system 100 via the invoking program 104. Assuming, for the sake of illustration, that the invoking program 104 is an email program, the untrusted program 112 enters the system 100 as an attachment to an email. Once in the system, the untrusted program 112 may be executed by a recipient of the email. Since the untrusted program 112 was brought into the system 100 via the email program 104, it is through the email program 104 that a recipient would execute the untrusted program 112.

When the email program 104 receives a command from a user to execute an untrusted program 112, it does not initially execute the untrusted program 112 in an unrestricted environment. Instead, the email program 104 invokes the environment establishment program 106 to first establish (204) a limited environment 110. In response, the environment establishment program 106 performs all of the operations necessary for setting up the limited environment 110. In one embodiment, this includes: (1) invoking the proper functions of the operating system 102 to create a limited environment 110; (2) specifying to the operating system 102 a root directory for the limited environment 110; and (3) specifying to the operating system 102 any other limitations (e.g. limit on memory usage) to be imposed on the limited environment 110. In one embodiment, the environment establishment program 106 specifies as the root directory of the limited environment 110 a directory that comprises mock resources 114. Once the limited environment 110 is established, it can be used to run the untrusted program 112.

Accordingly, the email program 104 proceeds to execute (208) the untrusted program 112 within the limited environment 110. In doing so, the email program 104 may allow the untrusted program 112 to execute fully, or it may termination execution prematurely. In either case, while the untrusted program 112 is executing within the limited environment 110, it has full access to the mock resources 114. Thus, the untrusted program 112 may manipulate the mock resources 114 in the same way that it would any real resource.

After the untrusted program 112 has executed, the email program 104 invokes the diagnostic program 108 to examine the limited environment 110 to check (212) for indications of undesirable behavior on the part of the untrusted program 112. In examining the limited environment 110, the diagnostic program 108 may look for certain types of behavior. For example, as mention previously, the diagnostic program 108 may determine whether any of the mock resources 114 were deleted, modified, renamed, moved, or accessed. In addition, the diagnostic program 108 may check for any other manipulation or modification of the limited environment 110. After examining the limited environment 110, the diagnostic program 108, in one embodiment, provides a report of its findings to a user. For example, this report may specify which mock resource 114 was accessed, modified, deleted, etc.

In addition, the diagnostic program 214 makes a determination (214), based upon its examination, whether the untrusted program 112 has exhibited any undesirable behavior. If so, then it may take (218) some corrective action. Corrective action may include, but is not limited to, providing a warning to a user that the untrusted program may be a virus, and hence, should not be executed, and deleting the untrusted program 112. On the other hand, if no undesirable behavior is detected, the diagnostic program 108 informs the email program 104 that the untrusted program 112 is probably not a malignant program. In such a case, the email program 104 allows (222) the untrusted program 112 to be executed in an unlimited environment. In the manner described, the system 100 detects malignant programs, and prevents them from damaging the system 100.

Thus far, the invention has been described assuming that an untrusted program enters the system 100 via an invoking program. While this is the most likely scenario, it is not the only possibility. For example, instead of being propagated through email, an untrusted program (e.g. virus) may be introduced into a system via a floppy disk. In such a case, a user can invoke the untrusted program directly, without going through an invoking program. In such a scenario, the present invention may still be used to prescreen the untrusted program, but it will take some action on the part of the user. More specifically, it will be up to the user to: (1) invoke the environment establishment program 106 to establish the limited environment 110; (2) execute the untrusted program 112 within the limited environment 110; and (3) invoke the diagnostic program 108 to examine the limited environment 110 after execution. If these steps are carried out, the untrusted program 112 can still be prescreened, even without the invoking program 104. This and other implementations are within the scope of the present invention.

### Hardware Overview

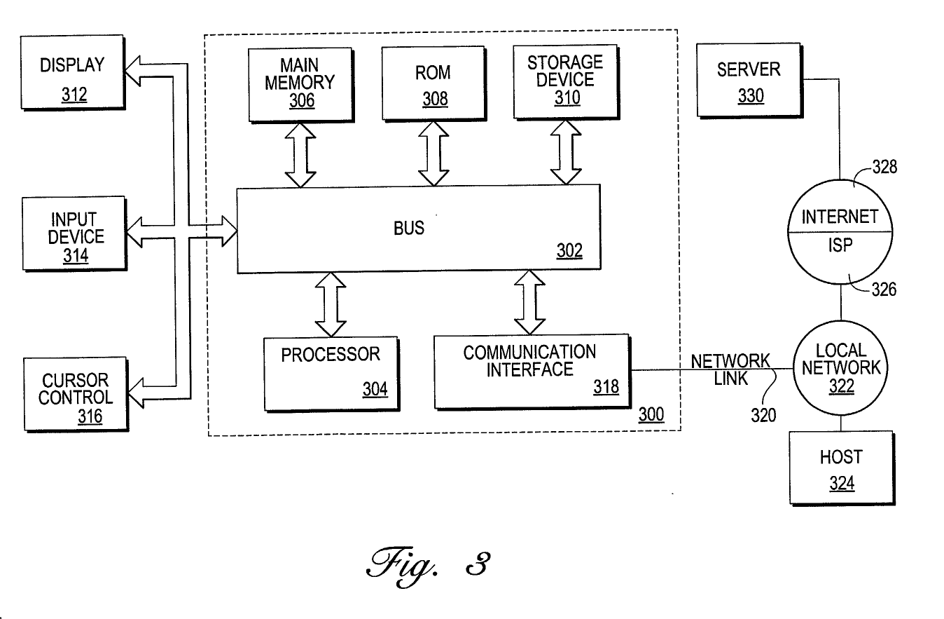

In one embodiment, the various components 104, 106, 108 of the present invention are implemented as sets of instructions executable by one or more processors. The invention may be implemented as part of an object oriented programming system, including but not limited to the JAVA™ programming system manufactured by Sun Microsystems, Inc. of Palo Alto, Calif. FIG. 3 shows a hardware block diagram of a computer system 300 in which an embodiment of the invention may be implemented. Computer system 300 includes a bus 302 or other communication mechanism for communicating information, and a process or 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 may also be further used to store temporary variables or other intermediate information during execution of instructions by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

According to one embodiment, the functionality of the present invention is provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or electromagnetic waves, such as those generated during radio-wave, infra-red, and optical data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution. In this manner, computer system 300 may obtain application code in the form of a carrier wave.

At this point, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the appended claims.

What is claimed is:

1. A computer-implemented method for executing an untrusted program, comprising:
establishing a limited environment, said limited environment comprising at least one mock resource;
executing at least a portion of an untrusted program within said limited environment; and
examining said limited environment after execution of at least said portion of said untrusted program to check for undesirable behavior exhibited by said untrusted program.

2. The method of claim 1, where said limited environment precludes access to actual resources, which if altered or accessed by said untrusted program, may lead to undesirable consequences.

3. The method of claim 1, wherein said limited environment comprises a shell in a UNIX operating system environment.

4. The method of claim 1, wherein examining said mock environment comprises:
determining whether said mock resource has been deleted.

5. The method of claim 1, wherein examining said mock environment comprises:
determining whether said mock resource has been renamed.

6. The method of claim 1, wherein examining said mock environment comprises:
determining whether said mock resource has been moved.

7. The method of claim 1, wherein examining said mock environment comprises:
determining whether said mock resource has been altered.

8. The method of claim 7, wherein said mock resource has a parameter associated therewith which changes when said mock resource is altered, and wherein determining whether said mock resource has been altered, comprises:
determining whether said parameter has changed.

9. The method of claim 8, wherein said parameter is a time value indicating when said mock resource was last updated.

10. The method of claim 1, wherein examining said mock environment comprises:
determining whether said mock resource has been accessed.

11. The method of claim 10, wherein said mock resource contains one or more sets of content, wherein said untrusted program executes in a particular portion of memory, and wherein determining whether said mock resource has been accessed comprises:
searching said particular portion of said memory for at least one of said one or more sets of content.

12. The method of claim 1, further comprising:
providing information indicating behavior exhibited by said untrusted program.

13. The method of claim 12, wherein said information comprises indications of undesirable behavior exhibited by said untrusted program.

14. The method of claim 1, further comprising:
determining whether said untrusted program has exhibited undesirable behavior; and
in response to a determination that said untrusted program has exhibited undesirable behavior, taking corrective action.

15. The method of claim 14, wherein taking corrective action comprises:
deleting said untrusted program.

16. The method of claim 14, wherein taking corrective action comprises:
providing a warning to a user.

17. A computer readable medium comprising instructions which, when executed by one or more processors, cause the one or more processors to execute an untrusted program, said computer readable medium comprising:
instructions for causing one or more processors to establish a limited environment, said limited environment comprising at least one mock resource;
instructions for causing one or more processors to execute at least a portion of an untrusted program within said limited environment; and
instructions for causing one or more processors to examine said limited environment after execution of at least said portion of said untrusted program to check for undesirable behavior exhibited by said untrusted program.

18. The computer readable medium of claim 17, where said limited environment precludes access to actual resources, which if altered or accessed by said untrusted program, may lead to undesirable consequences.

19. The computer readable medium of claim 17, wherein said limited environment comprises a shell in a UNIX operating system environment.

20. The computer readable medium of claim 17, wherein said instructions for causing one or more processors to examine said mock environment comprises:
instructions for causing one or more processors to determine whether said mock resource has been deleted.

21. The computer readable medium of claim 17, wherein said instructions for causing one or more processors to examine said mock environment comprises:
instructions for causing one or more processors to determine whether said mock resource has been renamed.

22. The computer readable medium of claim 17, wherein said instructions for causing one or more processors to examine said mock environment comprises:
instructions for causing one or more processors to determine whether said mock resource has been moved.

23. The computer readable medium of claim 17, wherein said instructions for causing one or more processors to examine said mock environment comprises:
instructions for causing one or more processors to determine whether said mock resource has been altered.

24. The computer readable medium of claim 23, wherein said mock resource has a parameter associated therewith which changes when said mock resource is altered, and wherein said instructions for causing one or more processors to determine whether said mock resource has been altered, comprises:
instructions for causing one or more processors to determine whether said parameter has changed.

25. The computer readable medium of claim 24, wherein said parameter is a time value indicating when said mock resource was last updated.

26. The computer readable medium of claim 17, wherein said instructions for causing one or more processors to examine said mock environment comprises:
instructions for causing one or more processors to determine whether said mock resource has been accessed.

27. The computer readable medium of claim 26, wherein said mock resource contains one or more sets of content, wherein said untrusted program executes in a particular portion of memory, and wherein said instructions for causing one or more processors to determine whether said mock resource has been accessed comprises:
instructions for causing one or more processors to search said particular portion of said memory for at least one of said one or more sets of content.

28. The computer readable medium of claim 17, further comprising:
instructions for causing one or more processors to provide information indicating behavior exhibited by said untrusted program.

29. The computer readable medium of claim 28, wherein said information comprises indications of undesirable behavior exhibited by said untrusted program.

30. The computer readable medium of claim 17, further comprising:
instructions for causing one or more processors to determine whether said untrusted program has exhibited undesirable behavior; and
instructions for causing one or more processors to, in response to a determination that said untrusted program has exhibited undesirable behavior, take corrective action.

31. The computer readable medium of claim 30, wherein said instructions for causing one or more processors to take corrective action comprises:
instructions for causing one or more processors to delete said untrusted program.

32. The computer readable medium of claim 30, wherein said instructions for causing one or more processors to take corrective action comprises:
instructions for causing one or more processors to provide a warning to a user.
